(19) United States
(12) Patent Application Publication
(10) Pub. No.: US 2026/0169206 A1
(43) Pub. Date: Jun. 18, 2026

(54) LIGHT CONTROL FILM

(71) Applicant: LMS Co., Ltd., Pyeongtaek-si (KR)

(72) Inventors: Moon Ho HAM, Pyeongtaek-si (KR); Jang Hee CHO, Pyeongtaek-si (KR); Woo Jong LEE, Pyeongtaek-si (KR); Ye Pil KWON, Pyeongtaek-si (KR); Gi Ho YI, Pyeongtaek-si (KR); Ju Hyun JANG, Pyeongtaek-si (KR); Min Jeong KWON, Pyeongtaek-si (KR); Min KWON, Pyeongtaek-si (KR); Sang Won CHO, Pyeongtaek-si (KR)

(21) Appl. No.: 19/336,474

(22) Filed: Sep. 22, 2025

(30) Foreign Application Priority Data
Dec. 17, 2024 (KR) 10-2024-0188904

(51) Int. Cl. G02B 5/20

(52) U.S. Cl. CPC G02B 5/201; G02B 2207/123

(57) ABSTRACT

Provided is a light control film. The light control film may include a louvered film having a first surface where light-absorbing portions and light-transmitting portions are alternately arranged and a second surface having the light-transmitting portions on an opposite side to the first surface. A line aperture ratio and an area aperture ratio may be adjusted for the light control film, and the brightness characteristics of the light control film can be controlled as desired.

### CROSS-REFERENCE TO RELATED APPLICATION(S)

This application is based on and claims priority under 35 U.S.C. 119 to Korean Patent Application No. 10-2024-0188904, filed on Dec. 17, 2024, in the Korean Intellectual Property Office, the disclosure of which is herein incorporated by reference in its entirety.

### TECHNICAL FIELD

The present specification relates to a light control film.

### BACKGROUND

A light control film is an optical film configured to control light transmittance. Various light control films are publicly known. A typical light control film includes a light-transmitting film having a plurality of parallel grooves, and the grooves are formed of a light-absorbing material. This type of film is also called as a louver film.

The light control film can be positioned close to a display surface, an image surface, or other surface. An image can be viewed at normal incidence (i.e., 0 degree viewing angle) where a viewer sees the image through the light control film in a direction perpendicular to the film surface. As the viewing angle increases, the amount of light transmitted through the light control film decreases until a viewing cut-off angle is reached where the light is blocked by the light absorbing material and the image is no longer visible. This can provide privacy to the viewer by blocking being seen by those who are out of the typical viewing angle range.

### SUMMARY

The objective of the present specification is to disclose a light control film.

The objective of the present specification is to disclose a light control film in which brightness characteristics are controlled as desired.

According to an embodiment of the present invention, there is provided that a light control film comprises a louver film having a first surface and a second surface where a light-absorbing portion and a light-transmitting portion are alternately arranged on the first surface, the second surface which is an opposite side to the first surface includes the light-transmitting portion, and the light control film satisfies Equation 1:

$$AR 1 / AR 2 < 1 \text{.45} ; \qquad [ Equation 1 ]$$

$$AR 1 = ( AB ) / A \times 100 ; and \qquad [ Equation 2 ]$$

$$AR 2 = ( p - L ) / p \times 100 , \qquad [ Equation 3 ]$$

where AR1 is defined by Equation 2; AR2 is defined by Equation 3; A is p×h, B is (U+L)×h/2, p is a pitch of the light-absorbing portion, h is a height of the light-absorbing portion, U is a width of the light-absorbing portion closer to the second surface, and L is a width of the light-absorbing portion on the first surface in Equation 2 and Equation 3.

In an embodiment, ΔCon in Equation 4 is less than 15%:

ΔCon=Con2−Con1 [Equation 4]

where Con1 is a center brightness of the light control film; Con2 is a peak brightness which is a maximum brightness value at an angle between −88 degrees and 88 degrees in a Horizontal Cross-Section; and the center brightness and the peak brightness mean a relative brightness with respect to a center brightness of a film with a laminated configuration excluding the louver film for the light control film.

In an embodiment, AR1/AR2 of Equation 1 is 1 or more for the light control film.

In an embodiment, the light-absorbing portion has a first wall angle (θ1) and a second wall angle (θ2) and a sum (θ) of the first wall angle (θ1) and the second wall angle (θ2) is in a range of 2 degrees to 8 degrees for the light control film.

In an embodiment, the height of the light-absorbing portion is in a range of 80 μm to 170 μm for the light control film.

In an embodiment, AR2 of Equation 1 is in a range of 33% to 96% for the light control film.

In an embodiment, AR1 of Equation 1 is in a range of 33% to 96% for the light control film.

In an embodiment, the light-absorbing portion is absent on the second surface of the louver film for the light control film.

In an embodiment, the light control film further comprises a first base film attached to the first surface of the louver film via an adhesive layer.

In an embodiment, the light control film further comprises a second base film in direct contact with the second surface of the louver film.

### BRIEF DESCRIPTION OF THE DRAWINGS

FIG. 1 is a side view of an exemplary light control film.

FIG. 2 is a front view of an exemplary light control film.

FIG. 3 is a drawing for explaining the wall angle of the absorbing portion.

FIG. 4 is a side view of an exemplary light control film.

FIG. 5 shows the results of brightness measurement for the light control film of Embodiment 1.

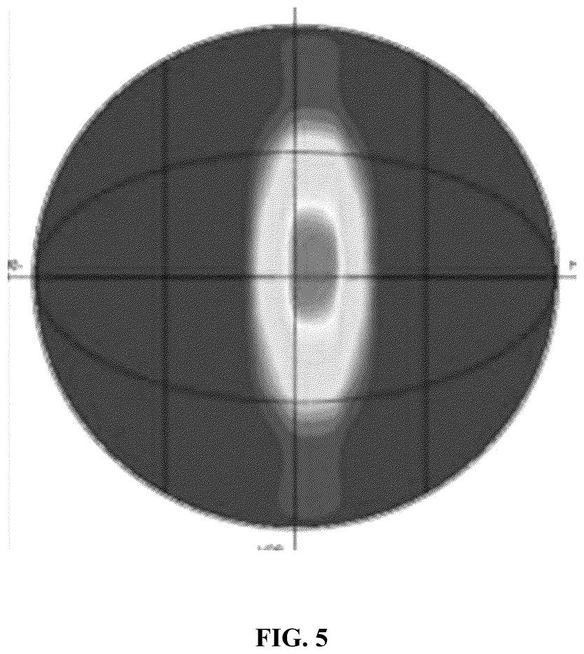

FIG. 6 shows the results of brightness measurement for the light control film of Embodiment 2.

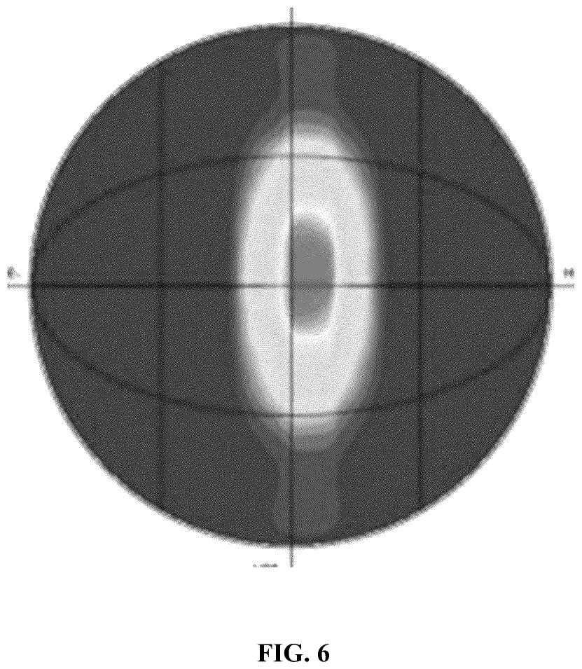

FIG. 7 shows the brightness measurement results for the light control film of Comparative Example 1.

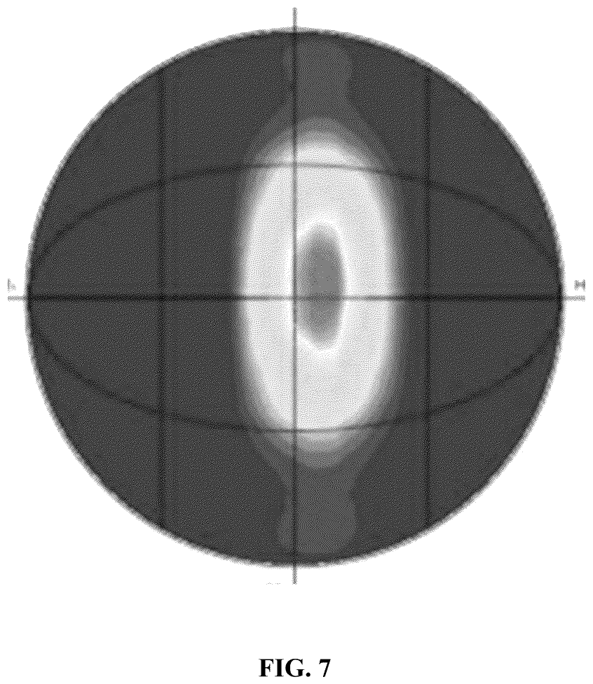

FIG. 8 shows the brightness measurement results for the light control film of Comparative Example 2.

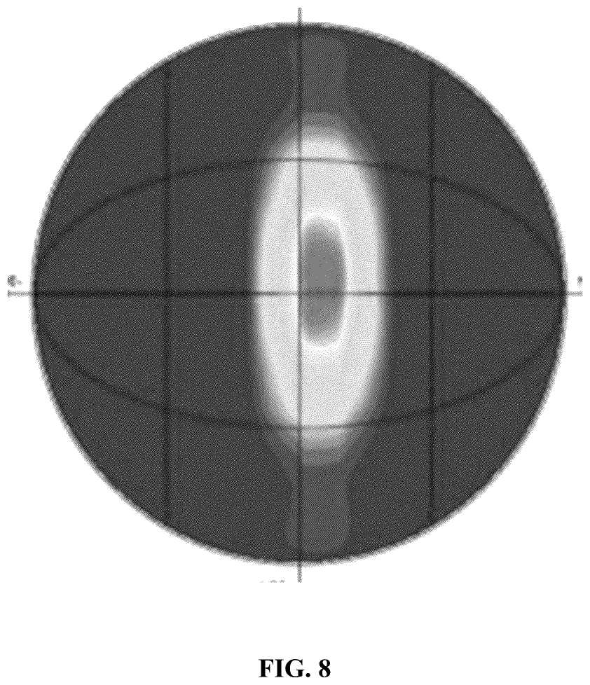

### DETAILED DESCRIPTION

Among the properties mentioned in this specification, properties whose results are affected by temperature measurement are the results measured at room temperature unless otherwise specifically stated.

A term ‘room temperature’ means the natural temperature that has not been artificially heated or cooled. For example, it means a certain temperature within a range of 10° C. to 30° C. or about 23° C. or about 25° C.

In this specification, the unit of temperature is Celsius (° C.) unless otherwise specified.

Among the properties mentioned in this specification, properties whose results are affected by pressure measurement are the results measured at atmospheric pressure unless specifically stated otherwise.

The term ‘atmospheric pressure’ is the natural pressure that has not been artificially pressurized or depressurized and usually means about 740 mmHg to 780 mmHg of the atmospheric pressure level.

In case where properties whose results are affected by humidity measurement in this specification, the properties are measured at natural humidity which is not artificially controlled under the above-mentioned room temperature and pressure conditions.

In this specification, a term ‘transmittance’, unless specifically specified otherwise, means the actual transmittance (actually measured transmittance) confirmed at a specific wavelength or a specific wavelength band.

In this specification, a term ‘incident angle’ means an angle formed by incident light and a normal line to a surface where the incident light is incident.

The present specification discloses a light control film. The light control film may include at least a louver film. The meaning of the louver film is publicly known.

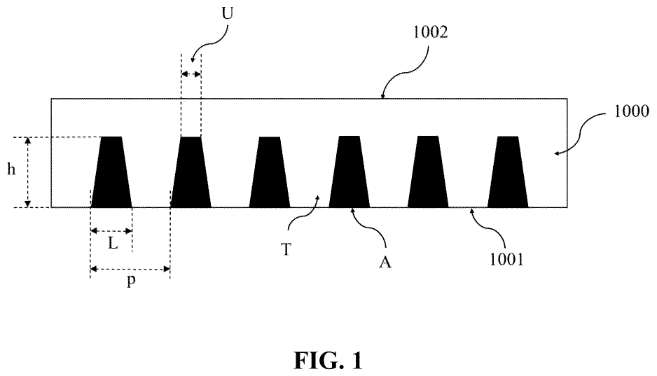

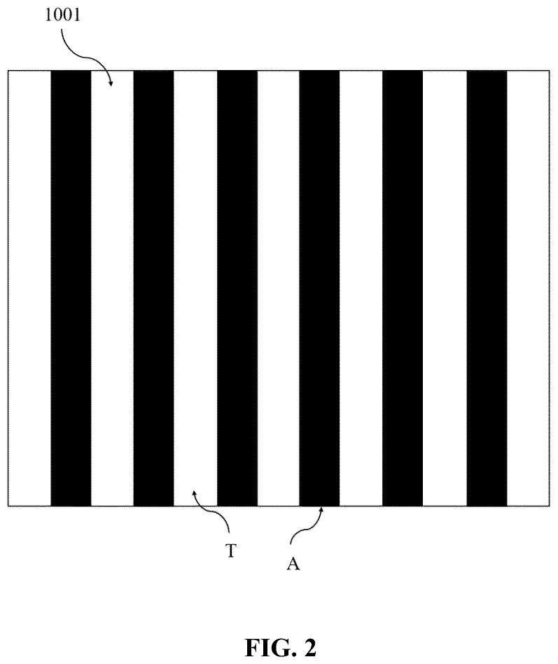

FIG. 1 is a side view of a typical louver film 1000. FIG. 2 is a front view of a first surface 1001 of the louver film 1000 of FIG. 1.

As shown in the drawing, the louver film has a first surface 1001 including alternately arranged light-absorbing portions (A) and light-transmitting portions (T) when they are observed from the front of the first surface 1001 and a second surface 1002 which is a surface opposite to the first surface 1001. The light-transmitting portions (T) exist on the second surface 1002. The light-absorbing portions (A) may not exist on the second surface 1002. Because of the light-transmitting portions (T), the light-absorbing portions (A) can be seen even when the louver film is observed from the second surface. In other words, the absence of the light-absorbing portions (A) on the second surface 1002 but being seen from the second surface 1002 means that the light-absorbing portions (A) do not directly contact with the second surface 1002 when the louver film is observed from the side as shown in FIG. 1.

The louver film disclosed in this specification can be formed so that AR1/AR2 of Equation 1 is within a predetermined range.

$$AR 1 / AR 2 \qquad [ Equation 1 ]$$

AR1 of Equation 1 is defined by Equation 2 below and AR1 can be called as area aperture ratio. AR2 of Equation 2 is defined by Equation 3 below and AR2 can be called as line aperture ratio.

$$AR 1 = ( A - B ) / ( A \times 100 ) \qquad [ Equation 2 ]$$

$$AR 2 = ( p - L ) / ( p \times 100 ) \qquad [ Equation 3 ]$$

In Equations 2 and 3, A is (p×h) and B is (U+L)×h/2 where p is a pitch of the light-absorbing portions, h is a height of the absorbing portions, U is a width of the absorbing portions closer to the second surface, and L is a width of the absorbing portions on the first surface. The pitch p is the distance between a starting point of one absorbing portion and another adjacent absorbing portion when the louver film is observed from the side. The p, h, L and U are exemplarily shown in FIG. 1.

The upper limit of AR1/AR2 of Equation 1 may be about 1.45, 1.4, 1.35, 1.3, 1.25, 1.2, or 1.15 and its lower limit may be about 1, 1.05, 1.1, 1.15, 1.2, 1.25, or 1.3. AR1/AR2 may be within a range that is less than or equal to any one upper limit arbitrarily selected from the above-mentioned upper limits or within a range that is less than or equal to any one upper limit arbitrarily selected from the above-mentioned upper limits and greater than or equal to any one lower limit arbitrarily selected from the above-mentioned lower limits. Within this range, the desired brightness characteristics of the light control film can be secured.

AR2 (line aperture ratio) of Equation 1 may be about 33%, 35%, 40%, 45%, or 50% and its upper limit may be about 96%, 95%, 90%, 85%, 80%, 75%, 70%, 65%, 60%, or 55%. AR2 may be within a range that is lower than or equal to any one upper limit arbitrarily selected from the upper limits mentioned above and higher than or equal to any one lower limit arbitrarily selected from the lower limits mentioned above. Within this range, the desired brightness characteristics of the light control film can be secured.

AR1 (area aperture ratio) of Equation 1 may be about 33%, 35%, 40%, 45%, 50%, 55%, 60%, or 65% and its upper limit may be about 96%, 95%, 90%, 85%, 80%, 75%, or 70%. AR1 may be within a range that is lower than or equal to any one upper limit arbitrarily selected from the upper limits mentioned above and higher than or equal to any one lower limit arbitrarily selected from the lower limits mentioned above. Within this range, the desired brightness characteristics of the light control film can be secured.

The ranges of p, h, L and U in the louver film can be adjusted to satisfy AR1 and AR2 and the corresponding ratio AR1/AR2. For example, the lower limit of the height h of the light-absorbing portions (A) in the louvered film may be about 80 μm, 90 μm, 100 μm, 110 μm, 120 μm, 130 μm, 140 μm, or 150 μm and its upper limit may be about 170 μm, 160 μm, 150 μm, 140 μm, 130 μm, 120 μm, 110 μm, or 100 μm. The height may be within a range that is lower than or equal to any one upper limit arbitrarily selected from the upper limits mentioned above and higher than or equal to any one lower limit arbitrarily selected from the lower limits mentioned above. Within this range, AR1, AR2 and the ratio AR1/AR2 can be effectively controlled.

For example, in the louver film 1000, the lower limit of the pitch p of the light-absorbing portions (A) may be about 20 μm, 25 μm, 30 μm, or 35 μm and the upper limit may be about 60 μm, 55 μm, 50 μm, 45 μm, or 40 μm. The pitch may be within a range that is lower than or equal to any one upper limit arbitrarily selected from the upper limits mentioned above and higher than or equal to any one lower limit arbitrarily selected from the lower limits mentioned above. Within this range, AR1, AR2, and the ratio AR1/AR2 can be effectively controlled.

The lower limit of the width U of the light-absorbing portions (A) closer to the second surface 1002 in the louver film 1000 may be about 0 μm, 0.5 μm, 1 μm, 1.5 μm, 2 μm, 2.5 μm, 3 μm, 3.5 μm, 4 μm, 4.5 μm, 5 μm, 5.5 μm, or 6 μm and the upper limit may be about 10 μm, 9.5 μm, 9 μm, 8.5 μm, 8 μm, 7.5 μm, 7 μm, 6.5 μm, 6 μm, 5.5 μm, 5 μm, 4.5 μm, 4 μm, 3.5 μm, 3 μm, 2.5 μm, 2 μm, 1.5 μm, 1 μm, or 0.5 μm. The width U of 0 μm refers to a case where the cross-section of the absorption portion is formed in a triangular shape and the upper part of the triangle is formed toward the second surface 1002. The width U may be within a range that is less than or equal to an upper limit arbitrarily selected from the upper limits mentioned above and greater than or equal to a lower limit arbitrarily selected from the lower limits mentioned above. Within this range, AR1, AR2, and the ratio AR1/AR2 can be effectively controlled.

In the louvered film 1000, the lower limit of the width L of the light-absorbing portions (A) on the first surface 1001 may be about 4 μm, 6 μm, 8 μm, 10 μm, 12 μm, 14 μm, 16 μm, or 18 μm and the upper limit may be about 22 μm, 20 μm, 18 μm, 16 μm, 14 μm, 12 μm, or 10 μm. The width L may be within a range that is less than or equal to any one upper limit arbitrarily selected from the above-mentioned upper limits and greater than or equal to any one lower limit arbitrarily selected from the above-mentioned lower limits. Within this range, AR1, AR2 and the ratio AR1/AR2 can be effectively controlled.

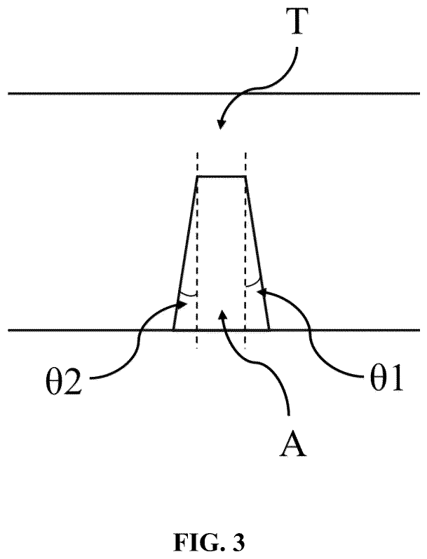

To satisfy the value mentioned above, the wall angle of the absorbing portions (A) can be adjusted. A wall angle is an angle formed between the surface normal of the louver film and side walls of the absorbing portions and is indicated as θ1 and θ2 in FIG. 3.

From the side view of the louvered film, the light absorbing portions can have a first wall angle (θ1) and a second wall angle (θ2). The lower limit of the sum (θ=θ1+θ2) of the first wall angle (θ1) and the second wall angle (θ2) can be about 2 degrees, 2.5 degrees, 3 degrees, 3.5 degrees, 4 degrees, 4.5 degrees, 5 degrees, 5.5 degrees, or 6 degrees and the upper limit can be about 8 degrees, 7.5 degrees, 7 degrees, 6.5 degrees, 6 degrees, 5.5 degrees, 5 degrees, 4.5 degrees, or 4 degrees. The sum (θ=θ1+θ2) can be within a range that is less than or equal to any one upper limit arbitrarily selected from the above-mentioned upper limits and greater than or equal to any one lower limit arbitrarily selected from the above-mentioned lower limits. Within this range, AR1, AR2 and their ratio AR1/AR2 can be effectively controlled.

A light control film including a louver film implemented in this configuration can have ΔCon of Equation 4 within a predetermined range.

$$Δ Con = Con 2 - Con 1 \qquad [ Equation 4 ]$$

In Equation 4, Con1 is the central brightness of the light control film. The central brightness is the luminance measured at the front (0 degrees) of the light control film. In Equation 4, Con2 is the maximum brightness value measured at an angle between −88 degrees and 88 degrees in the Horizontal Cross Section.

Brightness values of Con1 and Con2 in Equation 4 are relative brightness referenced to the central brightness measured for a laminated structure of the film excluding the louver film in the light control film, respectively.

The upper limit of ΔCon may be about 15%, 14%, 13%, 12%, 11%, 10%, 9%, 8%, 7.5%, 7%, 6.5%, 6%, 5.5%, 5%, 4.5%, 4%, 3.5%, 3%, or 2.5% and its lower limit may be about 0%, 0.5%, 1%, 1.5%, 2%, or 2.5%. ΔCon may be within a range that is less than or equal to any one upper limit arbitrarily selected from the above-mentioned upper limits or within a range that is less than or equal to any one upper limit arbitrarily selected from the above-mentioned upper limits and greater than or equal to any one lower limit arbitrarily selected from the above-mentioned lower limits. When ΔCon is controlled within this range, the display's visibility and brightness can be maintained uniformly depending on the left and right positions thereby improving image quality.

The louver film can be manufactured by a publicly known method as long as it satisfies the above-described configurations. Typically, the louver film can be manufactured by forming a louver film body (light-transmitting portion) in which grooves are formed by a so-called nano-imprinting process using a transparent resin material and filling the grooves of the body with a light-absorbing material to form a light-absorbing portion.

There is no particular limitation for the type of transparent resin material that can be used for the louver film. A typical material applicable for manufacturing the louver film can be used. The main body is formed by applying material that can be polymerized by light such as ultraviolet rays. Examples of such polymerizable material may include the well-known (meth) acrylate. Materials selected from monomers, (meth) acrylate oligomers and mixtures thereof are exemplified. The monomer or oligomer is any material that can be converted into a polymer by polymerization. The (meth) acrylate refers to both acrylate and methacrylate compounds. Examples of such materials may include (meth) acrylated urethane oligomers, (meth) acrylated epoxy oligomers, (meth) acrylated polyester oligomers, (meth) acrylated phenol oligomers, (meth) acrylated acrylic oligomers, and mixtures thereof.

Any suitable known material may be used as the light-absorbing material. Examples of which include, but are not limited to, carbon-based pigments and/or dyes.

The light control film may include other components as required in addition to the louver film. For example, the light control film may additionally include a first substrate film on the first surface of the louver film. The first substrate film may be attached to the first surface via an adhesive layer or the like.

For example, the light control film may further include a second substrate film on the second surface of the louver film. The second substrate film may be in direct contact with the second surface.

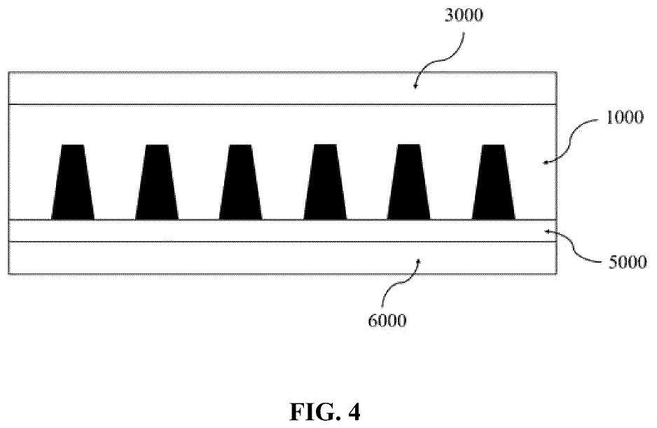

FIG. 4 is an example including a second base film 3000 directly in contact with a second surface of a louver film 1000 and a first base film 6000 attached to the first surface with an adhesive layer 5000. For the first and second substrate films, any known film can be used without special limitation. For applicable substrate films, examples thereof include, but are not limited to, an acrylic film such as a PMMA (polymethyl methacrylate) film, a PC (polycarbonate) film, a PET (polyethylene terephthalate) film, a polyurethane film, a TAC (triacetyl cellulose) film, or a polyurethane film.

A type of applicable adhesive to adhere the substrate film as described above to the louver film may not be especially limited, and for example, a known optical adhesive such as an acrylic-based, epoxy-based or silicone-based adhesive can be used. Such the light control films can be used for a variety of applications including a display device.

The light control film will be specifically described through the following embodiments, but the scope of the band pass filter or the like may not be limited by the following embodiments.

### Embodiment 1

A light control film was prepared as shown in FIG. 4. First, an ultraviolet-curable transparent resin material was applied on a second base film 3000 and a groove to form a light-absorbing portion (A) was formed by a nanoimprinting process to produce a light-transmitting body. Then, a light-absorbing material was filled in the groove to form the light-absorbing portion (A) and a first base film 6000 was attached through an adhesive layer 5000 to prepare a light control film.

A PET (polyethylene terephthalate) film having a thickness of about 150 μm was used as the first substrate film 6000 and a PET (polyethylene terephthalate) film having a thickness of about 150 μm was used as the second substrate film 3000. The thicknesses of the first and second substrate films may each be in a range of 80 μm to 150 μm. An acrylic adhesive was used as the adhesive layer 5000.

In addition, the louver film 1000 was formed to have a thickness of about 200 μm. The thickness of the louver film may be controlled, for example, within a range of 100 μm to 200 μm. An acrylic ultraviolet-curable resin (the ultraviolet-curable transparent resin material) was used as the material of the light-transmitting portions of the louver film 1000 and an acrylic ultraviolet-curable resin where carbon black pigment was dispersed was used as the light-absorbing material.

A refractive index for the light-transmitting portions of the louver film 1000 was approximately 1.50 to 1.56 with respect to a wavelength of 589 nm light. A refractive index for the light-absorbing portions was approximately 1.48 to 1.51 with respect to a wavelength of 589 nm light.

In the louver film, the pitch p of the light-absorbing portions (A), the height h of the light-absorbing portions (A), the width L of the light-absorbing portions on the first surface, the width U of the light-absorbing portions closer to the second surface, and the wall angle (the sum of θ1 and θ2 in FIG. 3) were adjusted as shown in Table 1 below.

### Embodiment 2 and Comparative Examples 1 and 2

A light control film was prepared as same as in Embodiment 1, except that the pitch p of the light-absorbing portions (A), the height h of the light-absorbing portions (A), the width L of the light-absorbing portions on the first surface, the width U of the light-absorbing portions closer to the second surface, and the wall angle (the sum of θ1 and θ2 in FIG. 3) in the louver film were adjusted as shown in Table 1 below. In Table 1 below, the units of the pitch p, the height h, the width L, and the U are m and the unit of the wall angle is degree.

TABLE 1

| | |
|---|---|
| Embodiment | Comparative Example |

| | 1 | 2 | 1 | 2 |
|---|---|---|---|---|
| p | 39 | 39 | 39 | 39 |
| h | 150 | 120 | 150 | 120 |
| L | 19 | 19 | 19 | 19 |
| U | 5.5 | 6 | 0 | 0 |
| θ1 + θ2 | 5.5 | 6.0 | 7.2 | 9.0 |

### Test Example 1

The brightness characteristics of the light control films of the embodiments and comparative examples were evaluated. The brightness was evaluated using equipment (Lighttools Simulation Program). AR1 (area aperture ratio) and AR2 (line aperture ratio) and the center brightness Con1 and the peak brightness Con2 calculated for each light control film are summarized and described in Table 2 below.

In Table 2, the relative brightness is the relative brightness to the reference brightness. In this case, the reference brightness is the brightness measured identically for a laminated film where the first base film 6000 and the second base film 3000 are laminated with an adhesive 5000 in the absence of the louver film.

In Table 2, the brightness Con1 is the center brightness of the light control film where the brightness was measured in a direction parallel to the surface normal direction of the light control film. In Table 2, the brightness Con2 is the maximum value of the brightness measured at an angle between −88 degrees and 88 degrees within the range of the Horizontal Cross Section and the angles of 88 degrees and −88 degrees are the angles measured based on the Center (0 degrees). In Table 2, ‘Relative’ in parentheses means that the corresponding brightness is relative brightness and ‘Absolute’ in parentheses means that the corresponding brightness is absolute brightness.

TABLE 2

| | Embodiment | | Comparative Example | |
|---|---|---|---|---|
| | 1 | 2 | 1 | 2 |
| AR1 | 69.7 | 67.4 | 75.6 | 75.6 |
| AR2 | 51.3 | 51.3 | 51.3 | 51.3 |
| AR1/AR2 | 1.36 | 1.32 | 1.48 | 1.48 |
| Con1 (Relative) | 58.9 | 57.3 | 53.6 | 51.1 |
| Con1 (Absolute) | 2609.8 | 2537.7 | 2376.9 | 2265.8 |
| Con2 (Relative) | 61.5 | 59.6 | 62.6 | 60.8 |
| Con2 (Absolute) | 2737.3 | 2651.3 | 2783.9 | 2706.1 |

From the results in Tables 1 and 2, it can be confirmed that the embodiments where AR1/AR2 is less than 1.45 can achieve excellent image quality by maintaining a high center brightness (Con1) and a low value of ΔCon. However, in the case of the comparative examples where AR1/AR2 exceeds 1.45, the center brightness is low and ΔCon is also confirmed to be a high value, therefore, it can be expected that a deterioration in image quality will occur.

What is claimed is:

1. A light control film comprising:
a louver film having a first surface and a second surface,
wherein a light-absorbing portion and a light-transmitting portion are alternately arranged on the first surface;
the second surface which is an opposite side to the first surface includes the light-transmitting portion; and
the light control film satisfies Equation 1:
[Equation 1]
AR1/AR2 < 1.45;
[Equation 2]
AR1 = (AB)/A × 100; and
[Equation 3]
AR2 = (p − L)/p× 100,
wherein AR1 is defined by Equation 2; AR2 is defined by Equation 3; A is p×h, B is (U+L)×h/2, p is a pitch of the light-absorbing portion, h is a height of the light-absorbing portion, U is a width of the light-absorbing portion closer to the second surface, and L is a width of the light-absorbing portion on the first surface in Equation 2 and Equation 3.

2. The light control film of claim 1, wherein ΔCon in Equation 4 is less than 15%:
[Equation 4]
ΔCon = Con2 − Con1,
wherein Con1 is a center brightness of the light control film; Con2 is a peak brightness which is a maximum brightness value at an angle between −88 degrees and 88 degrees in a horizontal cross-section; and the center brightness and the peak brightness mean a relative brightness with respect to a center brightness of a film with a laminated configuration excluding the louver film.

3. The light control film of claim 1, wherein AR1/AR2 of Equation 1 is 1 or more.

4. The light control film of claim 1, wherein the light-absorbing portion has a first wall angle (θ1) and a second wall angle (θ2) and a sum (θ) of the first wall angle (θ1) and the second wall angle (θ2) is in a range of 2 degrees to 8 degrees.

5. The light control of claim 1, wherein the height of the light-absorbing portion is in a range of 80 μm to 170 μm.

6. The light control film of claim 1, wherein AR2 of Equation 1 is in a range of 33% to 96%.

7. The light control film of claim 1, wherein AR1 of Equation 1 is in a range of 33% to 96%.

8. The light control film of claim 1, wherein the light-absorbing portion is absent on the second surface of the louver film.

9. The light control film of claim 1 further comprising: a first base film attached to the first surface of the louver film via an adhesive layer.

10. The light control film of claim 1 further comprising: a second base film in direct contact with the second surface of the louver film.
